(19) United States
(12) Patent Application Publication
(10) Pub. No.: US 2025/0091346 A1
(43) Pub. Date: Mar. 20, 2025

(54) ELECTRIC CIRCUIT BOARD AND LIQUID EJECTION HEAD

(71) Applicant: CANON KABUSHIKI KAISHA, Tokyo (JP)

(72) Inventors: SHIN ISHIMATSU, Kanagawa (JP); YUJI TAMARU, Tokyo (JP); YOSUKE TAKAGI, Kanagawa (JP); SHINICHIRO MATSUMOTO, Kanagawa (JP); HISAO OKITA, Kanagawa (JP); TOMOO IIZUMI, Kanagawa (JP); KIMIYUKI HAYASAKI, Kanagawa (JP); CHIAKI MURAOKA, Saitama (JP); TAKUHIRO OGUSHI, Kanagawa (JP); KENJIRO WATANABE, Tokyo (JP)

(21) Appl. No.: 18/888,658

(22) Filed: Sep. 18, 2024

(30) Foreign Application Priority Data
Sep. 19, 2023 (JP) 2023-151574

(51) Int. Cl. B41J 2/14; B41J 2/045; B41J 2/175; B41J 2/18

(52) U.S. Cl. CPC B41J 2/14072; B41J 2/04511; B41J 2/04541; B41J 2/0455; B41J 2/0458; B41J 2/04588; B41J 2/04596; B41J 2/17596; B41J 2/18; B41J 2002/14491

(57) ABSTRACT

An electric circuit board includes: a booster circuit configured to generate a pump drive signal by boosting a pump reference signal having a reference voltage based on a booster circuit drive signal; a first wiring for transmitting the pump drive signal; a second wiring for transmitting the pump reference signal; a third wiring for transmitting the booster circuit drive signal; and a plurality of fourth wirings for transmitting signals related to an ejection element configured to eject a liquid, wherein the second wiring and the third wiring each have a portion disposed at a position spaced apart from the first wiring by a distance shorter than a protection distance, and have a short circuit protection circuit connected thereto, and the plurality of fourth wirings include one or more first type wirings disposed at a position spaced apart from the first wiring by a distance longer than the protection distance.

### BACKGROUND OF THE DISCLOSURE

### Field of the Disclosure

The present disclosure relates to a circuit board and a liquid ejection head including the same.

### Description of the Related Art

Image forming apparatuses for printing on a printing material fall under the category of printers, multifunction machines, facsimile machines, and the like. Such image forming apparatuses are categorized by its printing method into ink jet type, wire dot type, thermal type, electrophotography, and the like. An ink jet image forming apparatus is also called a liquid ejection apparatus, and include a liquid ejection head having an ejection element for ejecting ink. The ejection element includes a pressure chamber, an ejection port, and an energy conversion element. In a liquid ejection apparatus, ink is supplied from an ink supply source to the pressure chamber through a channel. The ink supplied to the pressure chamber flies as flying droplets toward the printing material through the ejection port by ejection energy applied by the energy conversion element, and lands on the printing material. Printing is thus performed on the printing material. In particular, a liquid ejection head that uses thermal energy to eject ink has an advantage that the ejection ports can be arranged at a high density, making downsizing easy as a whole, and therefore has been put to practical use in many fields. Furthermore, there has recently been a liquid ejection apparatus that circulates a liquid in a liquid ejection head for the purpose of discharging air bubbles in a channel and preventing ink thickening near ejection ports. Japanese Patent Laid-Open No. 2018-30350 (hereinafter referred to as the document) discloses a liquid ejection apparatus that circulates ink in a liquid ejection head using a circulating pump.

In the liquid ejection apparatus disclosed in the document, the circulating pump is driven at a high voltage of 120 V to 300 V in a peak-to-peak manner in order to circulate the ink at a desired flow rate. Such a high voltage may have an undesirable effect on a user and peripheral components. In a case of a scanning type liquid ejection head that scans in a main scanning direction, it is desirable that an ink circulating channel is formed inside the head in order to avoid complicating the circulating channel and increasing the size of the apparatus. To form the circulating channel inside the head, the circulating pump is also disposed inside the head, which, however, increases the size of the head. The liquid ejection apparatus is increased in size as the head becomes larger. Therefore, to avoid the increase in size of the liquid ejection apparatus, downsizing the circulating pump is necessary. To achieve desired circulation capacity with the downsized circulating pump, it is necessary to drive the circulating pump at a high voltage. In a case of adopting a configuration in which a high voltage is supplied to the liquid ejection head from outside the liquid ejection head, it is necessary to provide an electric contact charged with a high voltage at the interface between the outside and the liquid ejection head. In this case, there is a possibility that a user may touch such an electric contact when replacing the liquid ejection head. To avoid this, a configuration may be adopted, for example, in which a booster circuit is provided inside the liquid ejection head to boost a low voltage inputted from the outside to a high voltage. However, it is also necessary to provide other circuits and wiring inside the liquid ejection head. For downsizing, the booster circuit, other circuits, and wiring need to be provided on the same electric circuit board. In such a case, there is a possibility that the high voltage outputted by the booster circuit may affect the other circuits and wiring.

### SUMMARY OF THE DISCLOSURE

One aspect of the present disclosure is an electric circuit board including: a booster circuit configured to generate a pump drive signal having a pump drive voltage for driving a circulating pump to circulate a liquid, by boosting a pump reference signal having a reference voltage based on a booster circuit drive signal; a first wiring for transmitting the pump drive signal; a second wiring for transmitting the pump reference signal; a third wiring for transmitting the booster circuit drive signal; and a plurality of fourth wirings for transmitting signals related to an ejection element configured to eject the liquid, wherein the second wiring and the third wiring each have a portion disposed at a position spaced apart from the first wiring by a distance shorter than a protection distance, and have a short circuit protection circuit connected thereto, and the plurality of fourth wirings include one or more first type wirings disposed at a position spaced apart from the first wiring by a distance longer than the protection distance.

Further features of the present disclosure will become apparent from the following description of exemplary embodiments with reference to the attached drawings.

### BRIEF DESCRIPTION OF THE DRAWINGS

FIG. 1A is a schematic perspective view showing a liquid ejection apparatus of the present disclosure, and FIG. 1B is a functional block diagram of the liquid ejection apparatus of the present disclosure;

FIG. 2 is an exploded perspective view of the liquid ejection head of the present disclosure;

FIG. 3 is a schematic external view of a liquid circulation unit of the present disclosure;

FIG. 4 is a schematic view of an ink circulation channel of the present disclosure;

FIG. 5 is a schematic view showing a configuration for electrical connection to drive a circulating pump;

FIG. 6 is a schematic plan view showing a layout of a mounting surface of an electric circuit board according to a first embodiment of the present disclosure;

FIG. 7 is a schematic perspective view of the electric circuit board of the present disclosure;

FIG. 8 is a schematic cross-sectional view including a through-hole of the electric circuit board of the present disclosure;

FIG. 9 is a list of representative wirings arranged on the electric circuit board of the present disclosure;

FIG. 10 is a schematic plan view showing a layout of a mounting surface of an electric circuit board according to a third embodiment of the present disclosure;

FIG. 11 is a schematic plan view showing a layout of a mounting surface of another electric circuit board according to the third embodiment of the present disclosure;

FIG. 12 is a schematic plan view showing a layout of a mounting surface of yet another electric circuit board according to the third embodiment of the present disclosure;

FIG. 13 is a schematic plan view showing a layout of a mounting surface of yet another electric circuit board according to the third embodiment of the present disclosure;

FIG. 14 is a schematic plan view showing a layout of a pad surface of an electric circuit board according to a fourth embodiment;

FIG. 15 is a schematic plan view showing a layout of a pad surface of an electric circuit board according to a fifth embodiment;

FIG. 16 is a schematic plan view showing a layout of a pad surface of an electric circuit board according to a sixth embodiment; and

FIG. 17 is a schematic plan view showing a layout of a mounting surface of an electric circuit board according to a seventh embodiment of the present disclosure.

### DESCRIPTION OF THE EMBODIMENTS

Hereinafter, embodiments will be described in detail with reference to the accompanying drawings. It should be noted that the following embodiments are not intended to limit the invention according to the claims. Although a plurality of features are described in the embodiments, not all the plurality of features are necessarily essential to the invention, and the features may be combined in any manner. In addition, the same or similar components may be denoted by the same reference numerals in the accompanying drawings, and repetitive description may be omitted.

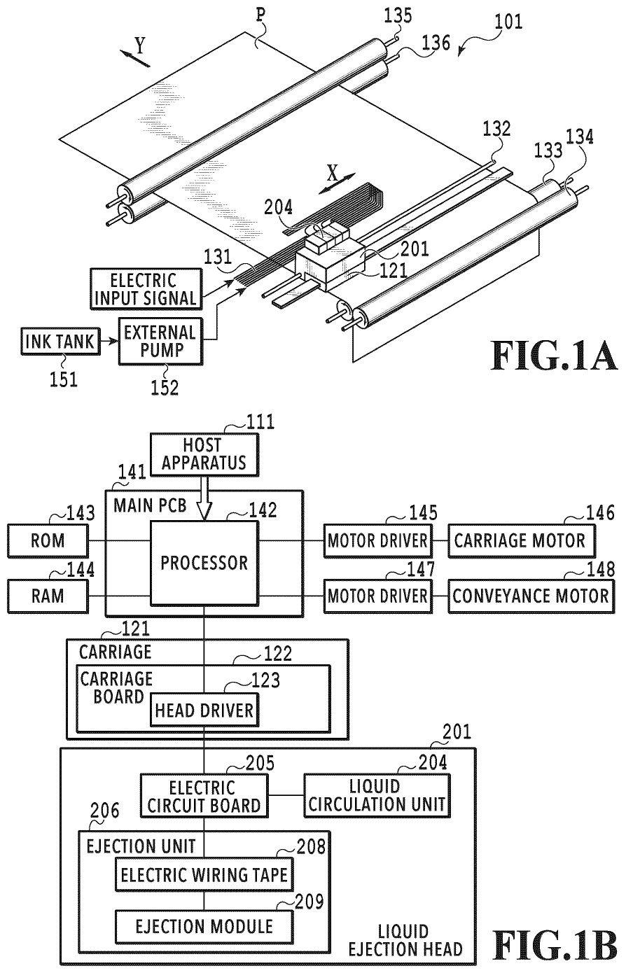

FIG. 1A is a schematic perspective view showing a liquid ejection apparatus of the present disclosure. FIG. 1B is a functional block diagram of the liquid ejection apparatus of the present disclosure.

The liquid ejection apparatus according to the present embodiment is a serial-scan ink jet printing apparatus (hereinafter simply referred to as the “printing apparatus”) 101 for printing an image on a printing medium P by ejecting ink from a liquid ejection head 201. The liquid ejection head 201 as an ink jet liquid ejection head is mounted on a carriage 121. The carriage 121 reciprocates along a guide shaft 132 extending in a main scanning direction, as indicated by a double-headed arrow X. The printing medium P is conveyed in a sub-scanning direction, which intersects with (in this example, orthogonal to) the main scanning direction, by conveyance rollers 133, 134, 135, and 136, as indicated by an arrow Y.

The liquid ejection head 201 includes a plurality of liquid circulation units 204 and an ejection unit 206. The plurality of liquid circulation units 204 circulate ink flowing through the ejection unit 206. An ejection module 209 provided in the ejection unit 206 has a plurality of ejection elements formed therein to eject the ink. An element drive signal generated by a head driver 123 drives the plurality of ejection elements to eject the ink, and is supplied to the plurality of ejection elements formed in the ejection module 209 via an electric circuit board 205 and an electric wiring tape 208.

A guide 131 is connected to the carriage 121. The guide 131 is provided with an electric wiring and a supply tube. An electric signal and ink required for ink ejection by the plurality of ejection elements formed in the ejection module 209 are supplied to the carriage 121 through such electric wiring and supply tube.

A processor 142 such as a CPU controls the printing apparatus 101 by reading and executing a program stored in a ROM 143. A RAM 144 is used as a work area for the processor 142 to read and execute the program. The processor 142 controls the head driver 123 based on image data supplied from a host apparatus 111 connected to the printing apparatus 101. The processor 142 also controls a carriage motor 146 for moving the carriage 121 via a motor driver 145. The processor 142 also controls a conveyance motor 148 for conveying the printing medium P by the conveyance rollers 133, 134, 135, and 136 via a motor driver 147.

The liquid ejection head 201 is capable of full-color printing using CMYK (cyan, magenta, yellow, and black) inks. A cap unit (not shown) is disposed adjacent to a conveyance path of the printing medium P. During a period in which the printing apparatus 101 does not perform any printing operation, the cap unit moves relatively to a position covering an ejection surface of the liquid ejection head 201, and performs capping to prevent ejection ports provided in the ejection surface from drying, filling the head with ink, and suctioning to restore the function of the head.

### (Description of Liquid Ejection Head Configuration)

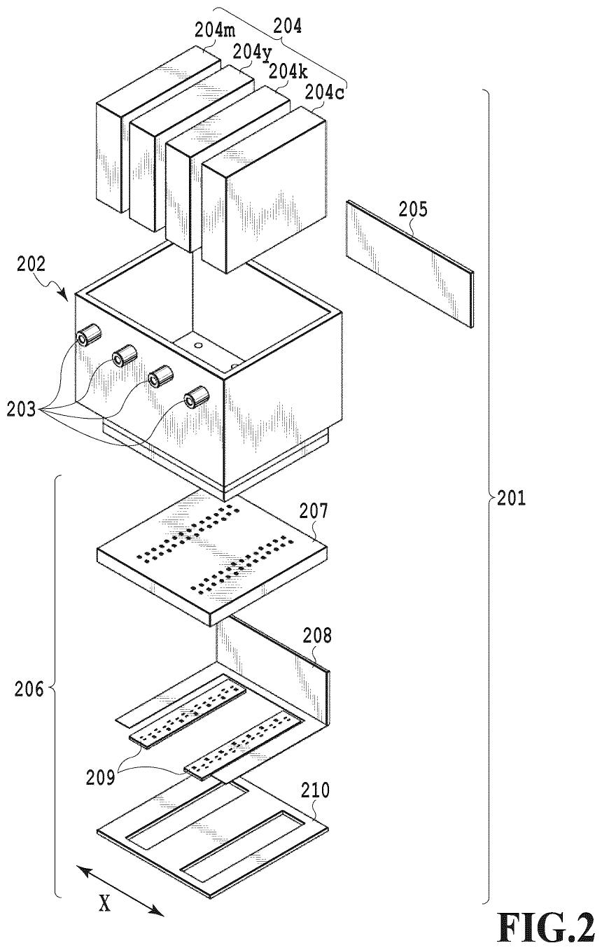

FIG. 2 is an exploded perspective view of the liquid ejection head 201 of the present embodiment. As shown in FIG. 2, the liquid ejection head 201 includes the plurality of liquid circulation units 204 as described above. The plurality of liquid circulation units 204 include circulation units 204m, 204y, 204k, and 204c corresponding to each color of ink, which are accommodated in a channel member 202. The circulation units 204 are each provided with a channel, and the channel member 202 is also provided with channels. A method for connecting these channels can be a screw fastening method with a seal member sandwiched therebetween, or a welding connection method. In the ejection head 201 according to the present embodiment, the number of types of ink is four, and accordingly the number of the circulation units 204 is also four, but the present disclosure is not limited thereto. The following description will be given assuming that the number of types of ink is four, but this does not mean that the number of types of ink in the present disclosure is limited to four.

As shown in FIG. 2, the channel member 202 is provided with four joints 203 for receiving ink supplied from the main body of the printing apparatus 101 through the supply tube provided in the guide 131. The four joints 203 are connected to the circulation units 204m, 204y, 204k, and 204c in a one-to-one relationship. When the liquid ejection head 201 is mounted on the main body of the printing apparatus 101, each supply tube connected to an ink tank 151 (see FIG. 1) of each color is connected to each joint 203. The ink of each color supplied through each supply tube is supplied to each of the circulation units 204m, 204y, 204k, and 204c through each joint 203. The ejection unit 206 is connected to the bottom surface of the channel member 202. The ink of each color supplied to each of the circulation units 204m, 204y, 204k, and 204c is supplied to the ejection unit 206 via the channel member 202.

As shown in FIG. 2, the ejection unit 206 includes the ejection module 209 having the plurality of ejection elements arranged therein to eject ink and a support member 207. The ejection unit 206 also includes the electric wiring tape 208 for sending an electric signal to the ejection module 209 and a cover member 210 for covering the electric wiring tape 208. The ejection module 209 and the electric wiring tape 208 are adhesively fixed to the support member 207, and the cover member 210 is adhesively bonded thereto so as to cover their surfaces. The ejection module 209 and the electric wiring tape 208 are electrically connected by wire bonding. Here, a method such as flying lead bonding can be used as an electrical connection method. The cover member 210 has an opening at a location corresponding to the ejection module 209. The ejection unit 206 and the channel member 202 can be connected by an adhesive method using an adhesive agent or a fixing method using screws with a seal member sandwiched therebetween.

The surface of the channel member 202 opposite to the surface on which the joints 203 are disposed is a contact surface. The electric circuit board 205 is disposed on the contact surface. The electric circuit board 205 may be fixed to the channel member 202 with a swage or an adhesive agent, or may be fixed with a two-sided adhesive tape.

As shown in FIG. 1, the electric circuit board 205 relays electric signals transmitted between a carriage board 122 and the ejection unit 206. The electric circuit board 205 also relays electric signals transmitted between the carriage board 122 and the liquid circulation unit 204.

The electric wiring tape 208 included in the ejection unit 206 is connected to the electric circuit board 205 by ACF pressure bonding, wire bonding, flying lead bonding, or the like. The electric wiring tape 208 relays electric signals transmitted between the electric circuit board 205 and the ejection module 209 included in the ejection unit 206.

### (Description of Circulation Channel)

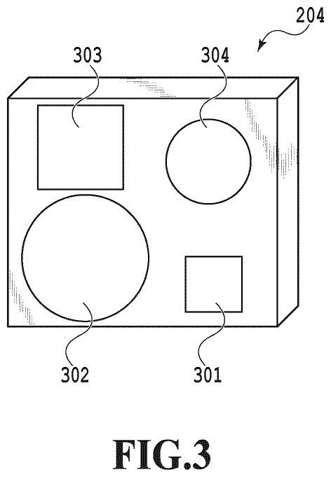

FIG. 3 is a schematic external view of the liquid circulation unit 204 applied to the printing apparatus 101. The liquid circulation unit 204 is disposed in the channel member 202, one for each color. In the liquid circulation unit 204, a first pressure adjustment mechanism 302, a second pressure adjustment mechanism 304, a filter 301, and a circulating pump 303 are disposed.

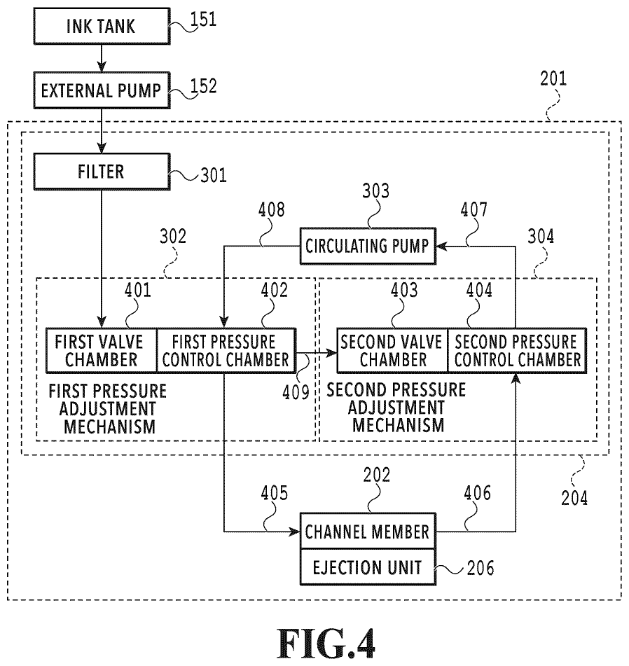

FIG. 4 is a schematic diagram showing a circulation channel for one color applied to the printing apparatus 101. Ink is pressurized and supplied from the ink tank 151 to the liquid ejection head 201 by an external pump 152. After dust is removed from the ink by a filter 301, the ink is supplied to a first valve chamber 401 of the first pressure adjustment mechanism 302. The pressure of the ink is then adjusted as it flows into a first pressure control chamber 402 communicated with the first valve chamber 401 through a valve (not shown).

The circulating pump 303 is a piezoelectric diaphragm pump that changes the volume inside the pump chamber by alternately inputting a pump drive signal having a pump drive voltage to two piezoelectric elements attached to the diaphragm, and pressure fluctuations cause two check valves to move alternately to send the ink. The circulating pump 303 is driven to send the ink from a pump inlet channel 407 on the downstream side to a pump outlet channel 408 on the upstream side.

The circulating pump 303 is driven to supply the ink with the pressure adjusted inside the first pressure control chamber 402 to a supply channel 405 and a bypass channel 409. The supply channel 405 is a channel formed in the channel member 202 and is connected to the ejection unit 206. A collecting channel 406 is also a channel formed in the channel member 202 and is connected to the ejection unit 206.

The ejection unit 206 includes the ejection module 209, and the ejection module 209 has the plurality of ejection elements formed therein. Each ejection element includes a pressure chamber, an ejection port, and an energy conversion element. The pressure chamber and the ejection port are communicated. The ejection ports are arranged as openings in the ejection surface. The ink supplied to the supply channel 405 is supplied to a plurality of pressure chambers formed in the ejection module 209 of the ejection unit 206. The ink in the pressure chamber is ejected from the ejection port by the energy outputted from the energy conversion element. The ink that is not ejected from the ejection port is discharged from the pressure chamber to the collecting channel 406, and is then supplied to a second pressure control chamber 404 of the second pressure adjustment mechanism 304.

The ink supplied to a second valve chamber 403 of the second pressure adjustment mechanism 304 is also supplied to the second pressure control chamber 404 that is communicated with the second valve chamber 403 through a valve.

The ink supplied to the second pressure control chamber 404 is supplied to the pump inlet channel 407 and to the pump outlet channel 408 after passing through the circulating pump 303, and is then supplied to the first pressure control chamber 402. However, at least some of the ink supplied to the second pressure control chamber 404 may be supplied to the channel member 202 through the collecting channel 406. Such a configuration in which the ink is circulated through the ejection elements formed in the ejection module 209 by the circulating pump 303 makes it possible to prevent the ink from thickening in the ejection module 209.

The circulation channel is not limited to such a configuration of passing through the ejection module 209, and may be configured to circulate the ink in the ejection unit 206 within a range that is effective in preventing the ink from thickening in the ejection module 209.

### (Description of Circulating Pump Drive Mechanism)

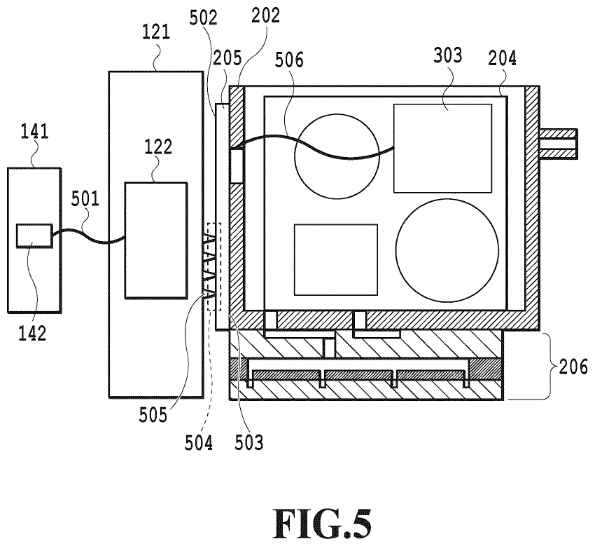

FIG. 5 is a schematic diagram showing a configuration for electrical connection to drive the circulating pump 303. Various drive signals are sent from the processor 142 mounted on a main PCB 141 in the printing apparatus 101 to the carriage board 122 (also referred to as the “upper board”) mounted on the carriage 121 through the main PCB 141 and a flexible flat cable (FFC) 501. The various drive signals include a signal related to the circulating pump 303 included in the liquid circulation unit 204 and a signal related to the ejection unit 206, which will be described later.

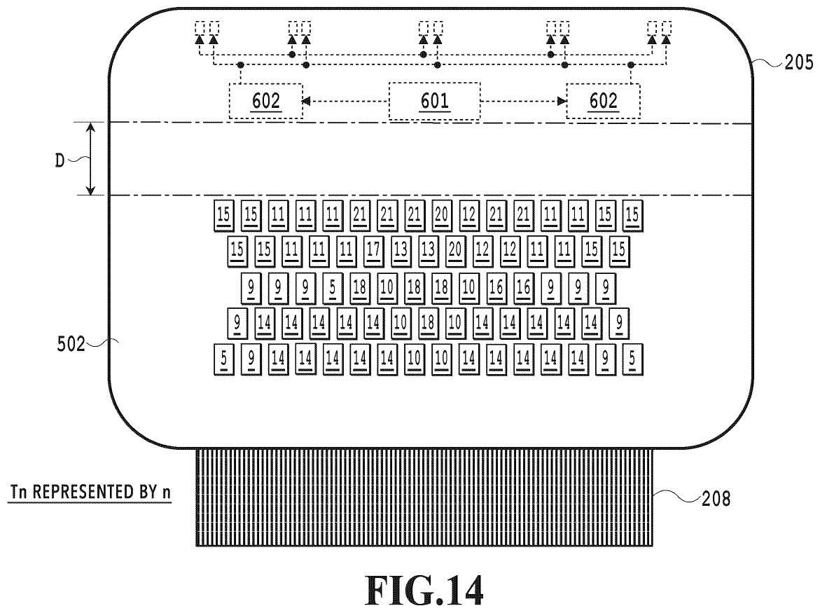

Various drive signals are also sent from the carriage board 122 to the electric circuit board 205 through an electric connection unit 504 using contact connection. Here, the electric connection unit 504 includes a plurality of pins 505 on the carriage 121 side as shown in FIG. 5 and a plurality of pads (also referred to as “upper terminals”) Tn (see FIG. 14) provided on a pad surface 502 of the electric circuit board 205, and electrical connection is established by each pin coming into contact with the pad corresponding thereto.

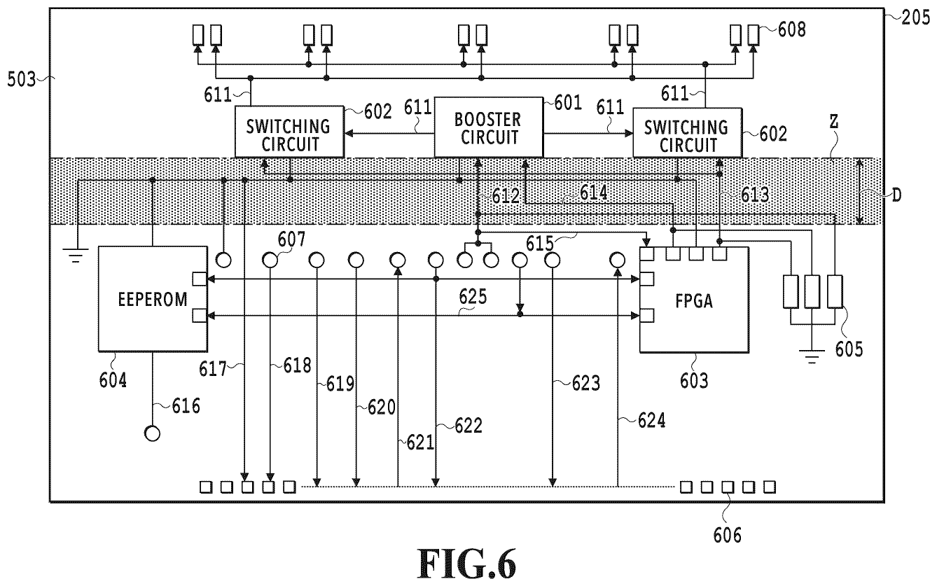

As described later, the electric circuit board 205 is provided with a booster circuit 601 (see FIG. 6) as boosting means for boosting the pump reference voltage of the pump reference signal based on a booster circuit drive signal. The booster circuit 601 boosts the pump reference voltage to a voltage specified by the booster circuit drive signal to generate a pump drive signal having a pump drive voltage. The pump drive signal is supplied to a connector terminal 608 (FIG. 6) provided on the electric circuit board 205 through a pair of switching circuits 602 (FIG. 6). The pump drive signal is supplied to the four circulating pumps 303 through a harness wiring 506 connected to the connector terminal 608. The four circulating pumps 303 are driven for ink circulation by the pump drive signal having the pump drive voltage.

### (Description of Driving Ejection Elements)

A signal for driving the plurality of ejection elements formed in the ejection module 209 is supplied to the electric circuit board 205 and then supplied to the ejection module 209 through the electric wiring tape 208. To describe some of the signals in more detail, various drive signals for driving the ejection elements are supplied to a differential transmission wiring and an analog signal wiring provided on the electric circuit board 205, and then supplied to the ejection module 209 through the electric wiring tape 208. The plurality of ejection elements formed in the ejection module 209 are driven at arbitrary timing and intensity by these drive signals.

### First Embodiment

FIG. 6 is a schematic diagram of a circuit provided on a mounting surface 503 of the electric circuit board 205 according to the first embodiment. As viewed from the mounting surface 503, the pad surface 502 on which the pad Tn contacted by the pin 505 is disposed is the opposite surface (see FIG. 5). In FIG. 6, reference numeral 612 denotes a pump reference signal wiring (also referred to as “second wiring”). A pump reference signal supplied from the pin 505 to a pad T20 (see FIG. 14) is supplied to the booster circuit 601 through a through-hole 607 and the pump reference signal wiring 612. The booster circuit 601 generates a pump drive signal having a pump drive voltage by boosting the pump reference voltage of the pump reference signal. Here, the pump drive voltage is specified by a booster circuit drive signal supplied from an FPGA 603 to the booster circuit 601 through a booster circuit drive signal wiring (also referred to as “third wiring”) 614. In the first embodiment, the pump reference voltage is 5 V, and the pump drive voltage is 70 V.

FIG. 6 shows four wirings denoted by reference numeral 611 on the mounting surface 503, which are collectively referred to as a pump drive signal wiring or first wiring. As described above, the pair of switching circuits 602 are provided on the electric circuit board 205. A pump drive signal having a pump drive voltage is continuously supplied to both switching circuits 602 through the pump drive signal wiring 611 arranged between the booster circuit 601 and each switching circuit 602. A pump drive control signal is supplied to the pair of switching circuits 602 from the FPGA 603 through a pump drive control signal wiring 613. The pair of switching circuits 602 generate a pump drive signal that complementarily repeats a pump drive voltage and zero volts, based on the pump drive control signal. Two series of connector terminals 608 are arranged on the electric circuit board 205. The pump drive signals generated by both switching circuits 602 are supplied to the two series of connector terminals 608 through the pump drive signal wiring 611 arranged between each switching circuit 602 and each series of connector terminals 608. Here, an input terminal of the circulating pump 303 is connected to the connector terminal 608 through the harness wiring 506. That is, one input terminal of each circulating pump 303 is connected to one series of connector terminals 608, and the other input terminal is connected to the other series of connector terminals 608. The pump drive signal having the pump drive voltage is thus alternately supplied to a pair of input terminals provided in each circulating pump 303. Focusing on one of the input terminals, the pump drive signal is intermittently supplied thereto.

Reference numeral 615 denotes an FPGA power source wiring for supplying power to operate the FPGA 603 to the FPGA 603. The FPGA 603 receives an IC control signal from the head driver 123 on the carriage board 122 through the electric connection unit 504, a pad T17 on the pad surface 502 (see FIG. 14), the through-hole 607, and an IC control signal wiring 625. The FPGA 603 then generates the pump drive control signal and booster circuit drive signal described above, based on the IC control signal.

Reference numeral 604 denotes an EEPEROM. The EEPEROM 604 receives an EEPEROM setting signal from the head driver 123 through the electric connection unit 504, a pad T16 on the pad surface (see FIG. 14), the through-hole 607, and an EEPEROM setting signal wiring 616. The EEPEROM 604 also generates a signal to be supplied to the FPGA 603, and further manages a signal indicating head drive conditions and the like.

Reference numeral 620 denotes a heater power supply wiring for supplying a heater power supply voltage for a heater to the energy conversion element (heater element in the present embodiment) provided in the ejection element formed in the ejection module 209. Reference numeral 619 denotes a heater ground wiring for supplying a heater ground voltage (0 V) corresponding to the heater power supply voltage to the energy conversion element.

Reference numeral 622 denotes a logic power supply wiring for supplying a logic power supply corresponding to a logic signal indicating drive timing or the like to the energy conversion element provided in the ejection element formed in the ejection module 209. Reference numeral 617 denotes a logic ground wiring for supplying a reference voltage (0 V) corresponding to the logic power supply to the energy conversion element. The logic power supply wiring 622 is also connected to the FPGA 603 and the EEPEROM 604 to supply the logic power supply wiring 622 to the FPGA 603 and the EEPEROM 604. The logic ground wiring 617 is also connected to the FPGA 603 and the EEPEROM 604 to supply a reference voltage corresponding to the logic power supply to the logic power supply wiring 622 and the logic ground wiring 617. The FPGA 603 and the EEPEROM 604 are logic circuits mounted on the electric circuit board 205.

Reference numeral 621 denotes an ejection element output wiring (analog) for transmitting an analog signal indicating the temperature of the ejection module 209 in a direction from the ejection module 209 to the electric connection unit 504.

Reference numeral 624 denotes an ejection element output wiring (digital) for transmitting a digital signal indicating a surface state of a heater electrode of the ejection module 209 in a direction from the ejection module 209 to the electric connection unit 504.

Reference numeral 618 denotes an ejection element drive signal wiring (differential) for supplying a signal indicating drive timing to the energy conversion element provided in the ejection element formed in the ejection module 209 by a differential transmission method. Reference numeral 623 denotes an ejection element drive signal wiring (non-differential) for supplying another signal indicating drive timing to the energy conversion element provided in the ejection element formed in the ejection module 209 by a method other than the differential transmission method.

Some of the wirings described above are connected to a lead terminal 606. The lead terminal 606 is connected to the ejection module 209 through the electric wiring tape 208.

Here, in the present embodiment, the pump drive signal wiring denoted by reference numeral 611 as described above has a pump drive signal with a pump drive voltage of 70V, for example, whether it is continuous or intermittent. This leads to a possibility of occurrence of ion migration due to the pump drive signal. The ion migration is a phenomenon in which metal ions contained in wiring to which high voltage is applied are eluted into the electric circuit board, the metal ions move through the electric circuit board toward the wiring on the low voltage side due to an electric field, and the metal ions that reach the wiring on the low voltage side combine with electrons and precipitate. The precipitation in the wiring on the low voltage side causes the growth of resin-like crystals called dendrites, which can cause short circuit between wirings.

Therefore, in the present embodiment, a protection area Z is provided around the pump drive signal wiring as a countermeasure against the ion migration. FIG. 6 schematically shows the protection area Z, and the upper side of the protection area Z coincides with the lower sides of the booster circuit 601 and the switching circuit 602. The lower side of the protection area Z is spaced downward from the upper side by a distance D. There is a possibility that the terminals of the booster circuit 601 and the switching circuit 602 connected to the pump drive signal wirings 611 may be located near the lower ends of these circuits 601 and 602. Taking such a possibility into consideration, the protection area Z is provided as shown in FIG. 6 so that other wirings are arranged so as to be spaced apart from the pump drive signal wiring 611 by at least the distance D, in principle. Here, the distance D is referred to as the protection distance.

There is also a configuration in which the terminals connected to the pump drive signal wirings 611 of the booster circuit 601 and the switching circuit 602 are located near the vertical center of these circuits 601 and 602, for example, and the pump drive signal wirings 611 are arranged so as to extend horizontally as viewed in FIG. 6. In such a configuration, the upper side of the protection area Z is located near the vertical center of the booster circuit 601 and the switching circuit 602. Therefore, the lower side of the protection area Z is also located above the position shown in FIG. 6. The protection area Z is not defined based on the positions of the booster circuit 601 and the switching circuit 602, but is defined by the position of the pump drive signal wiring 611 and the positions of the terminals (referred to as “associated terminals”) of the booster circuit 601 and the switching circuit 602 connected thereto. Here, the position of the associated terminal coincides with the position of one end of the pump drive signal wiring 611. The protection area Z is thus essentially defined by the position of the pump drive signal wiring 611.

In the example shown in FIG. 6, only the pump reference signal wiring 612, the pump drive control signal wiring 613, the booster circuit drive signal wiring 614, and the logic ground wiring 617 have portions disposed in the protection area Z. These four wirings 612, 613, 614, and 617 are wirings that need to be connected to one or both of the terminals of the booster circuit 601 and the switching circuit 602. Therefore, it is inevitable that these wirings have portions disposed in the protection area Z. However, a short circuit protection circuit 605 is connected to the three wirings 612, 613, and 614, except for the logic ground wiring 617, among the four wirings 612, 613, 614, and 617. By connecting the short circuit protection circuit 605 to the three wirings 612, 613, and 614, fire, smoke or the like is prevented even if these wirings 612, 613, and 614 are short-circuited with the pump drive signal wiring 611. Depending on the type of signal assigned to the wiring, the short circuit protection circuit 605 cannot be connected to the wiring. However, in terms of the pump reference signal wiring 612, the pump drive control signal wiring 613, and the booster circuit drive signal wiring 614, connecting the short circuit protection circuit 605 does not pose a problem. It is also possible to connect the short circuit protection circuit 605 to the logic ground wiring 617. However, since the short circuit protection circuit 605 would be connected between grounds, it is deliberately refrained from connecting the short circuit protection circuit to the logic ground wiring 617.

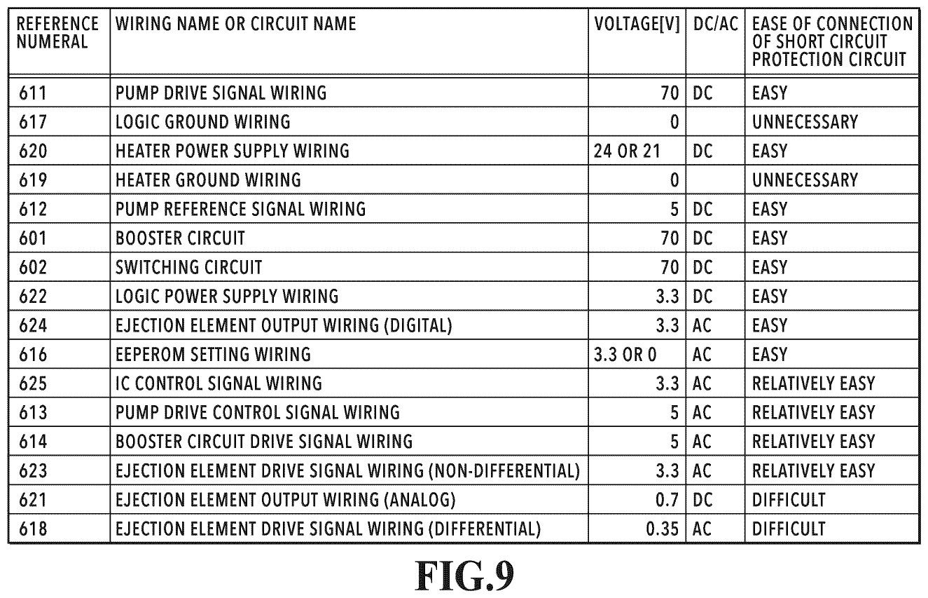

A Zener diode or a varistor, for example, can be used as the short circuit protection circuit 605. For example, a Zener diode or a varistor is inserted between the pump reference signal wiring 612 and the ground. This makes it possible to prevent the voltage of the pump reference signal wiring 612 from exceeding a breakdown voltage of the Zener diode or a limiting voltage of the varistor. As shown in a table of FIG. 9, which will also be referred to in the description below, a DC or AC signal of 5 V is assigned to the pump reference signal wiring 612, the pump drive control signal wiring 613, and the booster circuit drive signal wiring 614. Therefore, a Zener diode with a breakdown voltage of 5.5 V may be connected to these wirings.

All wirings other than the above four wirings 612, 613, 614, and 617 do not have a portion disposed in the protection area Z. In other words, all wirings other than the above four wirings 612, 613, 614, and 617 are disposed in an area excluding the protection area Z.

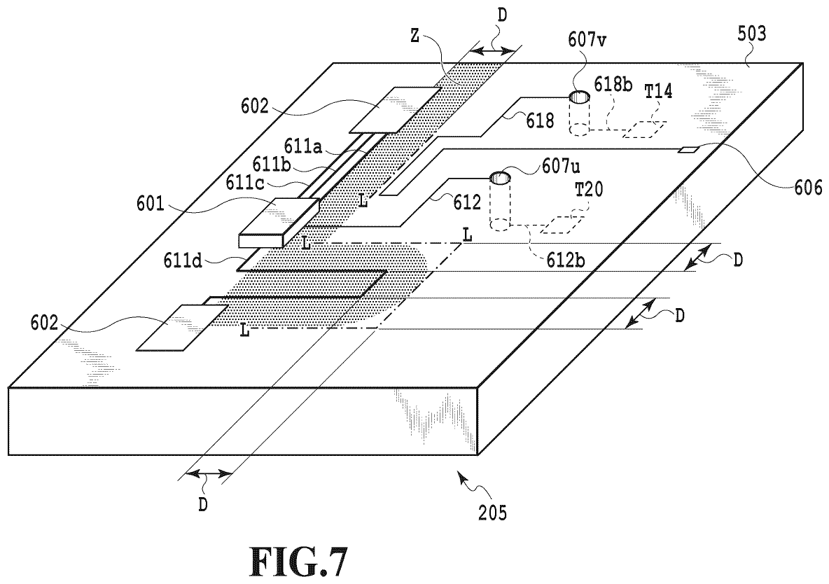

FIG. 7 is a schematic perspective view of the electric circuit board 205 of the present disclosure. Reference numeral 607u denotes a through-hole corresponding to the pump reference signal wiring 612. The through-hole 607u is connected to the pump reference signal wiring 612 disposed on the mounting surface 503 and a pump reference signal wiring 612b disposed on the pad surface 502. The pad T20 is disposed on the pad surface. On the pad surface 502, the pad T20 is connected to the pump reference signal wiring 612b. The pump reference signal wiring 612 is one first surface wiring (mounting surface wiring), and the pump reference signal wiring 612b is one second surface wiring (pad surface wiring).

The pump reference signal supplied from the pin 505 to the pad T20 is supplied to the booster circuit 601 through the pump reference signal wiring 612b, the through-hole 607u, and the pump reference signal wiring 612.

Reference numeral 607v denotes a through-hole corresponding to the ejection element drive signal wiring (differential) 618. The through-hole 607v is connected to the ejection element drive signal wiring (differential) 618 disposed on the mounting surface 503 and an ejection element drive signal wiring (differential) 618b disposed on the pad surface 502. A pad T14 is disposed on the pad surface 502. On the pad surface 502, the pad T14 is connected to the ejection element drive signal wiring (differential) 618b. On the mounting surface 503, the ejection element drive signal wiring (differential) 618 is connected to the lead terminal 606. The ejection element drive signal wiring (differential) 618 is one first surface wiring (mounting surface wiring), and the ejection element drive signal wiring (differential) 618b is one second surface wiring (pad surface wiring). The ejection element drive signal wiring (differential) 618 is composed of a plurality of signal wirings because a positive phase signal and a negative phase signal are paired. In FIG. 7, however, the ejection element drive signal wiring (differential) 618 is represented by a single line for simplicity.

The ejection element drive signal (differential) supplied from the pin 505 to the pad T14 is supplied to the lead terminal 606 through the ejection element drive signal wiring (differential) 618b, the through-hole 607v, and the ejection element drive signal wiring (differential) 618. The ejection element drive signal (differential) supplied to the lead terminal 606 is supplied to the plurality of ejection elements formed in the ejection module 209 through the electric wiring tape 208.

Reference numerals 611a, 611b, and 611c denote pump drive signal wirings. In FIG. 6, the pump drive signal wiring is represented by the single line 611. FIG. 7, on the other hand, shows a plurality of pump drive signal wirings 611a, 611b, and 611c to explain the concept of the protection distance D. Note that, in the present disclosure, the number of pump drive signal wirings is not limited, and a plurality of pump drive signal wirings 611a, 611b, and 611c may be provided.

A protection area Z11 having a boundary line at a position spaced apart from the pump drive signal wiring 611a by a distance D is defined on one side of the pump drive signal wiring 611a, and a protection area Z12 having a boundary line at a position spaced apart from the pump drive signal wiring 611a by the distance D is defined on the other side. Here, the combined area of the protection area Z11 and the protection area Z12 is defined as a protection area Z1. Similarly, a protection area Z21 having a boundary line at a position spaced apart from the pump drive signal wiring 611b by the distance D is defined on one side of the pump drive signal wiring 611b, and a protection area Z22 having a boundary line at a position spaced apart from the pump drive signal wiring 611b by the distance D is defined on the other side. The combined area of the protection area Z21 and the protection area Z22 is defined as a protection area Z2. Furthermore, a protection area Z31 having a boundary line at a position spaced apart from the pump drive signal wiring 611c by the distance D is defined on one side of the pump drive signal wiring 611c, and a protection area Z32 having a boundary line at a position spaced apart from the pump drive signal wiring 611c by the distance D is defined on the other side. The combined area of the protection area Z31 and the protection area Z32 is defined as a protection area Z3.

In the layout example shown in FIG. 7, the protection areas Z1, Z2, and Z3 partially overlap each other. An extended protection area Z=Z1∪Z2∪Z3 can be defined by taking the union of the protection areas Z1, Z2, and Z3.

A boundary line L between the extended protection area Z(=Z1∪Z2∪Z3) and the other area ¬Z(=¬(Z1∪Z2∪Z3)) can be defined as an outer periphery of the protection area Z for the entire pump drive signal wirings 611a, 611b, and 611c. The distance D from the boundary line L to the pump drive signal wiring closest to the boundary line L can be defined as the protection distance D described above for the entire pump drive signal wirings 611a, 611b, and 611c. In the example of FIG. 7, the pump drive signal wiring closest to the boundary line L is the pump drive signal wiring 611a.

The pump drive signal wiring 611d shown in FIG. 7 is bent, and thus a bent boundary line L can be defined. As shown in FIG. 7, a protection area Z and a protection distance D can be defined for the bent pump drive signal wiring 611d. The protection area Z is a set of points excluding points spaced apart from any point belonging to the pump drive signal wiring 611d by the distance D or more. The protection area Z can also be said to be a set of points Q2 spaced apart from at least one point Q1 belonging to the pump drive signal wiring 611d by the distance D or less. As shown in FIG. 7, around two bends on the protruding side (right side) of the pump drive signal wiring 611d, the protection area is centered at the bends and has a quadrant shape of radius D. However, the protection area Z may be defined differently in consideration of the distribution of electric field intensity near the pump drive signal wiring 611d.

Generally speaking, only one through-hole 607 may be provided for one electric wiring, or a plurality of through-holes may be provided for one electric wiring. Also, only one through-hole may be provided for one electrode terminal, or a plurality of through-holes may be provided for one electrode terminal. Furthermore, each electric wiring may be provided only on the mounting surface 503, only on the pad surface 502, or on both the mounting surface 503 and the pad surface 502 through the through-hole 607. Signal wiring for signals shared by a plurality of devices may branch off in the middle.

In the present embodiment, the through-hole 607 has a diameter of 0.6 mm and a copper plating thickness of 25 μm, and the number of through-holes is set to less than or equal to 0.75 Å per one through-hole.

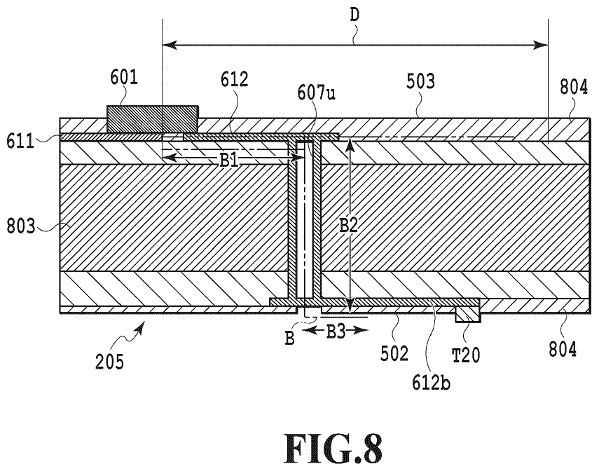

FIG. 8 is a schematic cross-sectional view including a through-hole of the electric circuit board 205 of the present disclosure. Specifically, FIG. 8 is a schematic cross-sectional view including the through-hole 607u connected to the pump reference signal wiring 612. Reference numeral 803 denotes a core material of the electric circuit board 205, and reference numeral 804 denotes a resist layer that covers the electric wiring.

In the layout shown in FIG. 7, the through-hole 607u is provided in an area other than the protection area Z. In FIG. 8, on the other hand, the through-hole 607u is purposely disposed in the protection area for the sake of explanation. The following description is based on such a hypothetical configuration, but in reality, some kind of through-hole may be disposed in the protection area Z.

With reference to FIG. 8, the pump reference signal wiring 612 is connected to the booster circuit 601. The pump reference signal wiring 612b disposed on the pad surface 502 is connected to the pump reference signal wiring 612 through the through-hole 607u provided in the protection area Z. The pad T20 is disposed on the pad surface 502, and is connected to the pump reference signal wiring 612b. The pump drive signal wiring 611 is also disposed on the mounting surface 503. In the left-right direction of FIG. 7, the right end position of the pump drive signal wiring 611 substantially coincides with the center position of the booster circuit 601.

B1 represents the distance between the pump drive signal wiring 611 and the through-hole 607u. B2 represents the thickness of the electric circuit board 205. If B1+B2<D, a protection area having a radius B3 (>0) can be defined on the pad surface 502. The radius B3 is expressed by B3=D−(B1+B2). This results in B1+B2+B3=D.

Specifically, in the configuration where B1+B2<D as shown in FIG. 8, the protection area Z is extended to the pad surface 502. In other words, the range that defines the protection distance D from the pump drive signal wiring 611 to the boundary line between the protection area Z and the other area is extended to the pad surface 502. The protection distance D is thus measured by the creepage distance across the mounting surface 503, the through-hole, and the pad surface 502. This is because ion migration due to the pump drive signal on the pump drive signal wiring 611 does not pass through the core material 803, but extends from the mounting surface 503 to the pad surface 502 through the through-hole 607u. That is, metal ions eluted from the pump drive signal wiring 611 may reach the pad surface 502 through the through-hole 607u.

Note that the wiring 612 is provided in the example shown in FIG. 8, but the presence or absence of the wiring 612 is irrelevant to the extension of the protection area Z to the pad surface 502. Specifically, if some kind of through-hole penetrating the electric circuit board 205 is provided in the protection area Z as viewed from the mounting surface 503, the protection area Z can be extended to the pad surface 502 regardless of what wiring is connected to the through-hole. Furthermore, the protection area Z can be extended to the pad surface 502 even if no wiring is connected to the through-hole provided in the protection area Z as viewed from the mounting surface 503. If the through-hole penetrating the electric circuit board 205 is provided in the protection area Z as viewed from the mounting surface 503, it is preferable to adjust the wiring on the pad surface 502 taking into account the protection area Z across the mounting surface 503 and the pad surface 502 as described above. More specifically, a circular range (circular range whose center is the through-hole and whose radius is B3) from the through-hole provided in the protection area Z to the distance B3 (=D−(B1+B2)) can be defined as the protection area on the pad surface. Based on this definition, it is preferable that the wiring is arranged so as to avoid the protection area on the pad surface 502.

FIG. 9 shows a list of representative wirings arranged on the electric circuit board 205 of the present disclosure. As shown in this list, the wirings are classified into a wiring easy to connect to the short circuit protection circuit, a wiring relatively easy to connect thereto, a wiring difficult to connect thereto, and a wiring not required to connect thereto. The wiring easy to connect to the short circuit protection circuit is a wiring that does not cause any problem even if an inexpensive short circuit protection circuit is connected thereto. The wiring relatively easy to connect to the short circuit protection circuit is a wiring that does not cause any problem if a short circuit protection circuit that is not inexpensive is connected thereto. The wiring difficult to connect to the short circuit protection circuit is a wiring that causes a problem if the short circuit protection circuit is connected thereto.

The voltage of the heater power supply wiring is expressed as “24 or 21”, meaning that there is more than one heater power supply wiring, some of which have a voltage of 24 V and the others have a voltage of 21 V. The voltage of the EEPEROM setting signal wiring is expressed as “33 or 0”, meaning that there is more than one EEPEROM setting signal wiring, some of which have a voltage of 3.3 V and the others have a voltage of 0 V.

As shown in the table of FIG. 9, a high voltage of 70 V is applied to the pin connected to the pump drive signal wiring 611 of the booster circuit 601, the pin connected to the pump drive signal wiring 611 of the switching circuit 602, and the pump drive signal wiring 611. The protection distance D starting from these points is set to 6 mm. This value of 6 mm is a distance set to satisfy the conditions stipulated for the clearances in secondary circuits in “2. 10. 3. 4 Clearances in secondary circuits” in IEC 60950-1, a standard by the International Standardization Organization.

The electric circuit board 205 according to the present embodiment was subjected to an actual print durability test for 2000 hours of power application time with the printing apparatus 101 including the same in an environment of 90% humidity and 35° C. temperature, and it was confirmed that good printing can be performed.

### Second Embodiment

In the first embodiment, the protection distance D has a value of 6 mm as an example. However, the protection distance D has a value set by the power application time required for the printing apparatus 101 and a voltage difference between the pump drive voltage generated by the booster circuit 601 and the voltage of the signal on the wiring adjacent to the booster circuit 601, and is not limited to 6 mm. The protection distance D may be set to satisfy the conditions stipulated in other rules.

In the first embodiment, the voltage of the pump drive signal wiring 611 is 70V. On the other hand, in a case where the voltage of the pump drive signal wiring 611 is 35 V, for example, the voltage difference between the pump drive voltage of the pump drive signal generated by the booster circuit 601 and the voltage of the signal on the wiring adjacent to the booster circuit 601 is smaller than that in the first embodiment. This slows down the progress of ion migration. Therefore, the protection distance D may be set shorter than in the first embodiment. If the rule is changed to, for example, “the clearance distance is 3 mm if there is a 40 V high-voltage wiring using other rules”, the wiring position may be changed according to the changed rule.

An actual print durability test operation was conducted for 2000 hours of power application time in an environment of 90% humidity and 35° C. temperature with the same configuration as the first embodiment except that the protection distance D was actually set to 5 mm and the pump drive voltage of the pump drive signal for driving the circulating pump 303 was set to 35V. It was confirmed that good printing was achieved in this actual print durability test operation.

### Third Embodiment

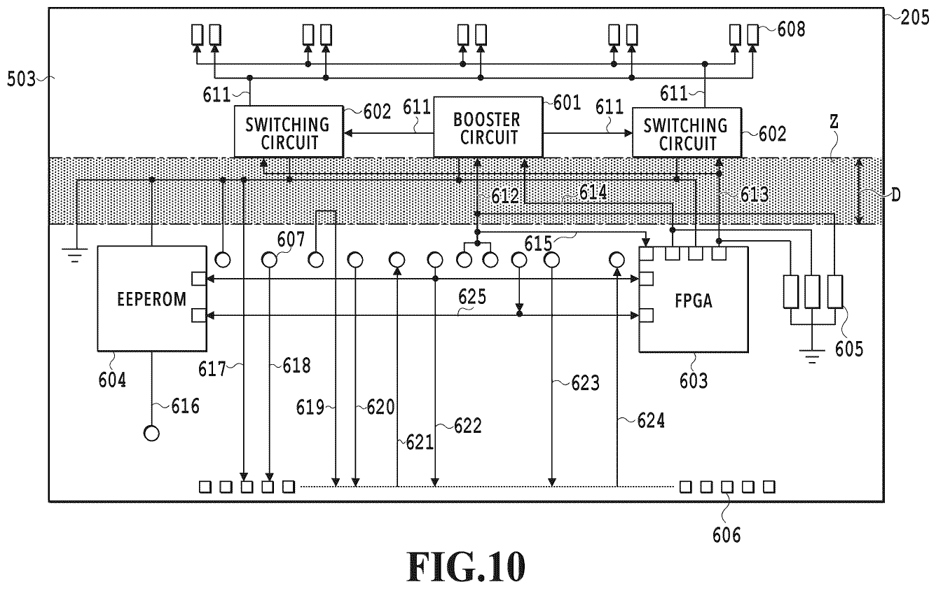

In the third embodiment, as shown in FIG. 10, the heater ground wiring 619, which does not need to connect to a protection element that is a short circuit protection circuit, may have a portion disposed in the protection area.

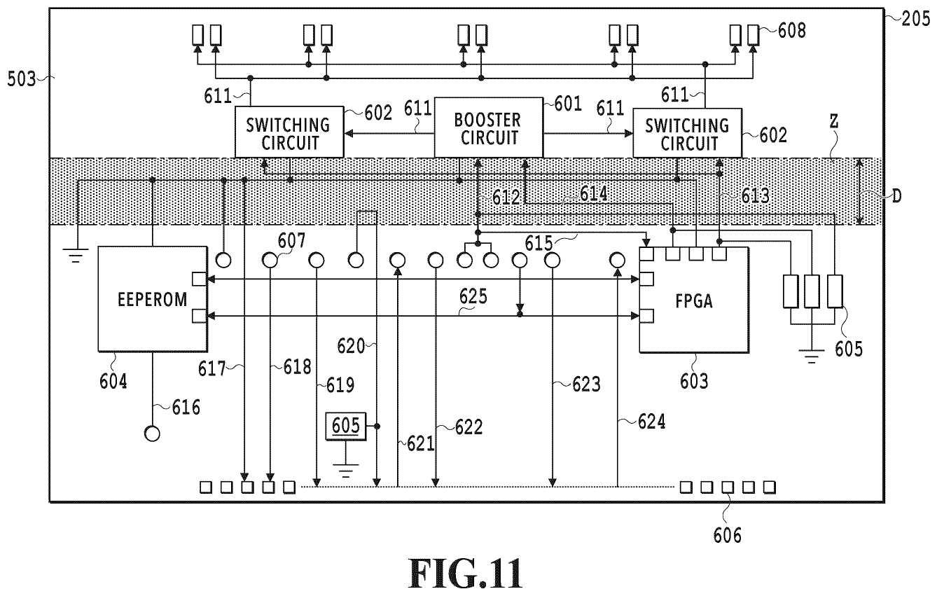

As shown in FIG. 11, the heater power supply wiring 620, which has a voltage with a smaller potential difference from the pump drive voltage of the pump drive signal wiring 611, may have a portion disposed in the protection area Z. However, a protection element 605, which is a short circuit protection circuit, is connected to the heater power supply wiring 620. As shown in the table of FIG. 9, there is more than one heater power supply wiring 620, some of which have a voltage of 24 V and the others have a voltage of 21 V.

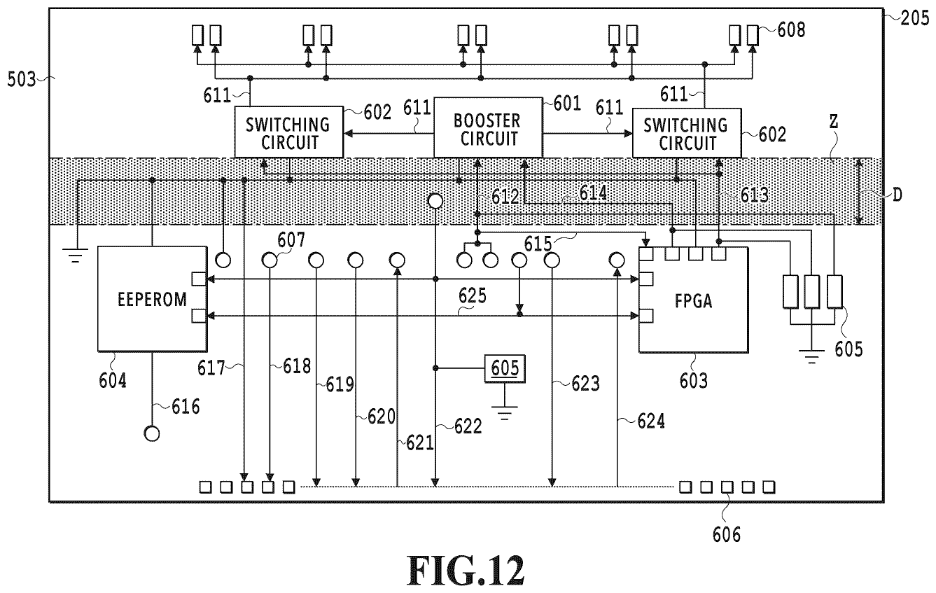

Furthermore, as shown in FIG. 12, the logic power supply wiring 622, which has a voltage with a larger potential difference from the pump drive voltage of the pump drive signal wiring 611, may have a portion disposed in the protection area Z. However, a protection element 605, which is a short circuit protection circuit, is connected to the logic power supply wiring 622. As shown in the table of FIG. 9, the logic power supply wiring 622 has a voltage of 3.3 V.

On the other hand, it is avoided that the short circuit protection circuit is connected to the ejection element drive signal wiring (differential) 618. The ejection element drive signal wiring (differential) 618 is then disposed in an area other than the protection area Z. The reason is as follows. If the short circuit protection circuit is connected to the ejection element drive signal wiring (differential) 618, the rise/fall of the voltage waveform of the ejection element drive signal transmitted through the ejection element drive signal wiring (differential) 618 becomes slow. Therefore, high-speed data transfer for high-speed printing required for the ink jet printing head cannot be performed. As the rise/fall of the voltage waveform becomes slow, the accuracy of detecting the original signal from the differential signal also deteriorates. Therefore, it is avoided that the short circuit protection circuit is connected to the ejection element drive signal wiring (differential) 618, and the ejection element drive signal wiring (differential) 618 is thus disposed in an area other than the protection area Z.

It is also avoided that the short circuit protection circuit is connected to the ejection element output wiring (analog) 621. The ejection element output wiring (analog) 621 is then disposed in an area other than the protection area Z. The reason is as follows. An analog temperature signal indicating the temperature of the ejection module 209 by voltage is outputted from a temperature measurement terminal provided in the ejection module 209. The analog temperature signal is transmitted from the liquid ejection head 201 to the main PCB 141 through the ejection element output wiring (analog) 621 and other wirings. If a short circuit protection circuit is connected to the ejection element output wiring (analog) 621, an error such as an offset occurs in the temperature-to-voltage characteristics of the analog temperature signal, preventing measurement of the accurate temperature of the ejection module 209 on the main PCB 141. This also prevents the ink ejection volume from being accurately controlled taking into account the temperature of the ejection module 209, which adversely affects the print quality. Therefore, as described above, it is avoided that the short circuit protection circuit is connected to the ejection element output wiring (analog) 621, and the ejection element output wiring (analog) 621 is disposed in an area other than the protection area Z.

In the present embodiment, the protection distance D is set to 6 mm, and the pump drive signal for driving the circulating pump 303 has a pump drive voltage of 70 V. The rest of the configuration is the same as in the first embodiment. In the configuration shown in FIG. 11, the short circuit protection circuit is connected to the heater power supply wiring 620, and the heater power supply wiring 620 is partially disposed in the protection area Z. An actual print durability test was conducted for 2000 hours of power application time in an environment of 90% humidity and 35° C. temperature with this configuration, and good printing was still achieved

On the other hand, in a reference configuration in which a short circuit protection circuit is connected to the ejection element output wiring (analog) 621, and the ejection element output wiring (analog) 621 is partially disposed in the protection area Z, deterioration in print quality is observed.

In another reference configuration in which a short circuit protection circuit is connected to the ejection element drive signal wiring (differential) 618 and the ejection element drive signal wiring (differential) 618 is partially disposed in the protected area, high-speed printing cannot be performed.

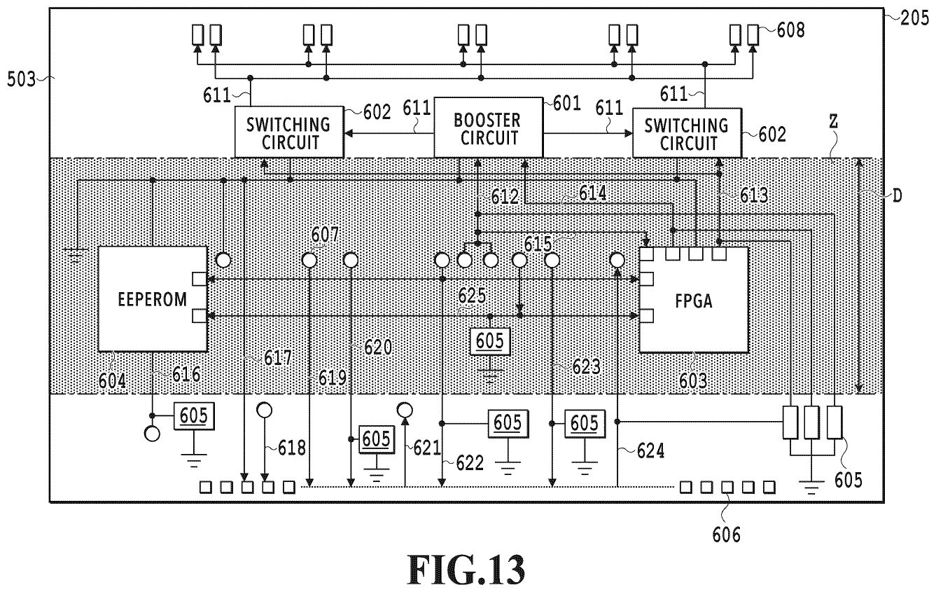

Therefore, in order to ensure the freedom of wiring, as shown in FIG. 13, the ejection element output wiring (analog) 621 and the ejection element drive signal wiring (differential) 618 are disposed in the area excluding the protected area Z. One or more other wirings may have a portion disposed in the protected area Z. However, a short circuit protection circuit is connected to at least some of the wirings included in the one or more other wirings having the portion disposed in the protected area Z.

The magnifying scale of FIG. 13 is larger than that of FIGS. 10 to 12. The protection distance D shown in FIGS. 10 to 12 and the protection distance D shown in FIG. 13 appear different on the drawings, but are the same in reality. Therefore, the electric circuit board 205 shown in FIG. 13 is smaller than the electric circuit board 205 shown in FIGS. 10 to 12.

In the configuration shown in FIG. 13, the ejection element drive signal wiring (differential) 618 and the ejection element output wiring (analog) 621 are disposed in the area excluding the protection area Z. The wiring thus disposed in the area excluding the protection area Z is referred to as a first type wiring.

In the configuration shown in FIG. 13, there are more wirings having portions disposed in the protection area Z. This increases the number of wirings required to connect to the short circuit protection circuit. The EEPEROM setting signal wiring 616, the logic ground wiring 617, the heater ground wiring 619, and the heater power supply wiring 620 have portions disposed in the protection area Z. The logic power supply wiring 622, the ejection element drive signal wiring (non-differential) 623, the ejection element output wiring (digital) 624, and the IC control signal wiring 625 also have portions disposed in the protection area Z.

It is then necessary to connect a short circuit protection circuit to at least some of these wirings. Specifically, as shown in FIG. 13, the short circuit protection circuit is connected to the EEPEROM setting signal wiring 616, the heater power supply wiring 620, and the logic power supply wiring 622. The short circuit protection circuit is also connected to the ejection element drive signal wiring (non-differential) 623, the ejection element output wiring (digital) 624, and the IC control signal wiring 625. Such wirings having portions disposed in the protection area Z and having the short circuit protection circuit connected thereto are referred to as a second type wiring.

As shown in the table of FIG. 9, DC or AC signals of 3.3 V, 21 V or 24 V are assigned to the wirings 616, 620, 622, 623, 624, and 625. A Zener diode having a breakdown voltage slightly higher than the voltage of the signal assigned to each wiring is connected to each wiring. For example, a Zener diode having a breakdown voltage of 3.6 V is connected to a wiring to which a signal of 3.3 V is assigned.

No short circuit protection circuit is connected to the logic ground wiring 617 and the heater ground wiring 619. Such wirings having portions disposed in the protection area Z and have no short circuit protection circuit connected thereto are referred to as a third type wiring. The short circuit protection circuit is preferably connected to the heater power supply wiring 620, but does not necessarily have to be connected thereto.

### Fourth Embodiment

FIG. 14 is a layout diagram of pads included in the electric connection unit 504 according to the first embodiment. The pads Tn are arranged on the pad surface 502 of the electric circuit board 205. Each pad is connected to a wiring disposed on the mounting surface 503, and the correspondence between the number n included in each pad Tn in FIG. 14 and the wiring is as follows:
5: Logic ground wiring 617
9: Ejection element output wiring (analog) 621
10: Ejection element output wiring (digital) 624
11: Heater power supply wiring 620
12: FPGA power supply wiring 615
13: Logic power supply wiring 622
14: Ejection element drive signal wiring (differential) 618
15: Heater ground wiring 619
16: EEPEROM setting signal wiring 616
17: IC control signal wiring 625
18: Ejection element drive signal wiring (non-differential) 623
20: Pump reference signal wiring 612
22: (Blank)

Although not shown in FIG. 14, through-holes are provided at adjacent positions in contact with each pad to eliminate wiring on the pad surface 502. Therefore, in plan view, the through-hole corresponding to each pad is arranged at substantially the same position as each pad. The through-hole corresponding to each pad connects each pad to the corresponding wiring arranged on the mounting surface 503. Note that wiring connecting each pad to each through-hole may be arranged on the pad surface 502.

In the examples shown in FIGS. 10, 11, and 12, the through-hole 607 is arranged in an area below the protection area Z. That is, the through-hole 607 is arranged at a position spaced apart from the pump drive signal wiring 611 by a distance longer than the predetermined protection distance D. Therefore, as shown in FIG. 14, each pad is also arranged at a position spaced apart from the pump drive signal wiring 611 by a distance longer than the predetermined protection distance D in plan view. This eliminates the need for the protection area Z of radius B3, as described with reference to FIG. 8, to be provided on the pad surface 502.

Note that blind vias and buried vias used in multilayer boards are different from the through-holes described here.

### Fifth Embodiment

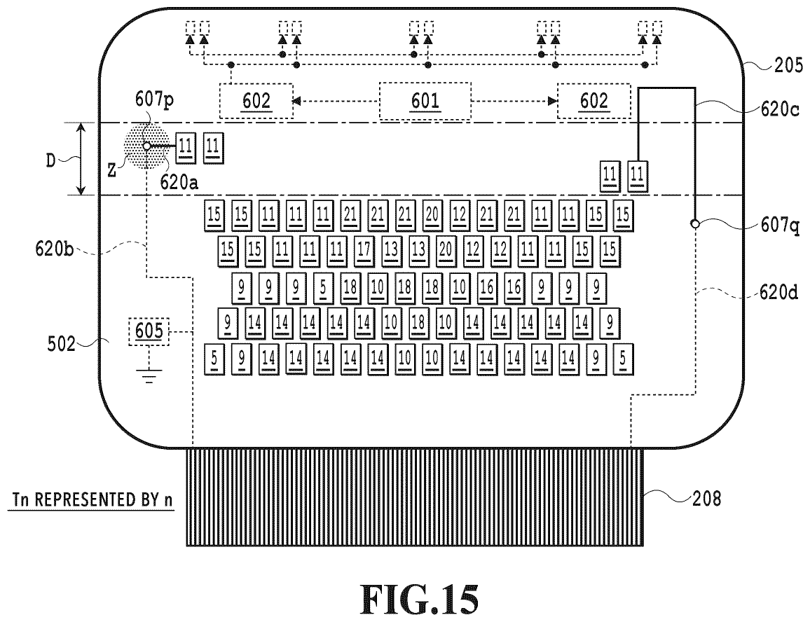

In the fourth embodiment, as shown in FIG. 14, all the pads are arranged at positions spaced apart from the pump drive signal wiring 611 by a distance longer than the predetermined protection distance D in plan view. In a fifth embodiment, on the other hand, some of the pads are arranged at positions spaced apart from the pump drive signal wiring 611 by a distance shorter than the predetermined protection distance D in plan view, as shown in FIG. 15. That is, some of the pads are arranged at positions that belong to the protection area Z in plan view.

In the example shown in FIG. 15, four pads T11 marked with the number 11 are arranged at positions spaced apart from the pump drive signal wiring 611 by a distance shorter than the predetermined protection distance D in plan view. The pads T11 are connected to the heater power supply wiring 620.

The wiring for the pad located at the left end among the four pads T11 is as follows. Specifically, a through-hole 607p is disposed at a position that belongs to the protection area Z in plan view (that is, a position spaced apart from the pump drive signal wiring 611 by a distance shorter than the predetermined protection distance D). A heater power supply wiring 620a for connecting the pad to the through-hole 607p is also provided on the pad surface 502, and a heater power supply wiring 620b for connecting the through-hole 607p to the lead terminal 606 is provided on the mounting surface 503. The lead terminal 606 is connected to the wiring on the electric wiring tape 208. Therefore, on the mounting surface 503, the heater power supply wiring 620b has a portion disposed at a position that belongs to the protection area Z (that is, a position spaced apart from the pump drive signal wiring 611 by a distance shorter than the predetermined protection distance D). Here, in the example shown in FIG. 13, it is described that a short circuit protection circuit is preferably connected to the heater power supply wiring 620. In the example shown in FIG. 15, a short circuit protection circuit 605 is thus connected to the heater power supply wiring 620b corresponding to the pad located at the left end among the four pads T11. Alternatively, a short circuit protection circuit (not shown) may be connected to the heater power supply wiring 620a.

The wiring for the pad located at the right end among the four pads T11 is as follows. Specifically, a through-hole 607q is disposed at a position that does not belong to the protection area Z in plan view (that is, a position spaced apart from the pump drive signal wiring 611 by a distance longer than the predetermined protection distance D). A heater power supply wiring 620c for connecting the pad to the through-hole 607q is also provided on the pad surface 502, and a heater power supply wiring 620d for connecting the through-hole 607q to the lead terminal 606 is provided on the mounting surface 503. The lead terminal 606 is connected to the wiring on the electric wiring tape 208. Therefore, the heater power supply wiring 620d is disposed at a position that does not belong to the protection area Z (that is, a position spaced apart from the pump drive signal wiring 611 by a distance longer than the predetermined protection distance D). Therefore, there is no need to connect a short circuit protection circuit to the heater power supply wiring 620d corresponding to the pad disposed at the right end among the above four pads T11. There is also no need to connect a short circuit protection circuit to the heater power supply wiring 620c.

As described above, the through-hole 607p is disposed at a position that belongs to the protection area Z in plan view (that is, a position spaced apart from the pump drive signal wiring 611 by a distance shorter than the predetermined protection distance D). Therefore, as described with reference to FIG. 8, a circular protection area Z can be defined on the pad surface 502, which is centered at the through-hole 607p and has the radius B3. On the pad surface 502, the above four pads T11, including the pad at the left end, are arranged in the area excluding the protection area Z shown in FIG. 15.

### Sixth Embodiment

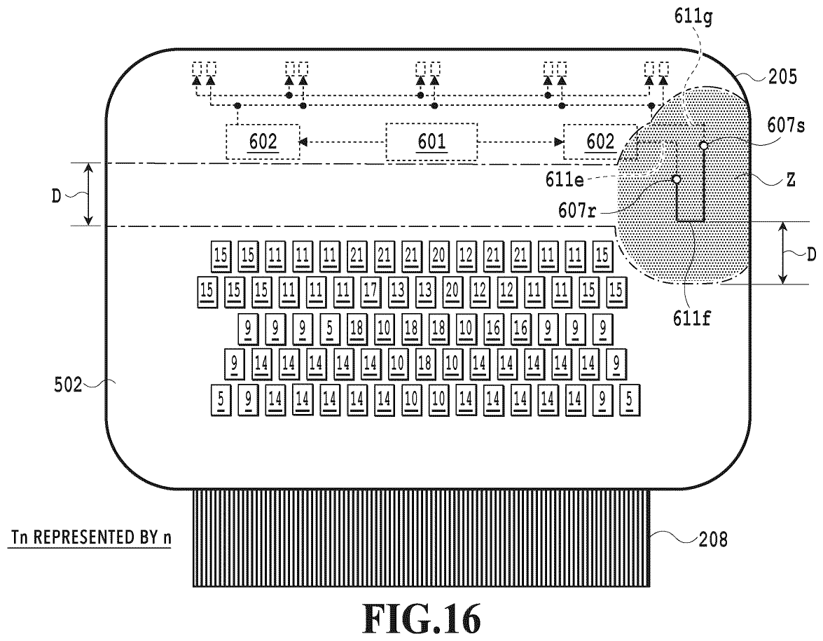

In the fourth and fifth embodiments, the pump drive signal wiring 611 is disposed only on the mounting surface 503. In a sixth embodiment, on the other hand, the pump drive signal wiring 611 is disposed not only on the mounting surface 503 but also on the pad surface 502, as shown in FIG. 16. In FIG. 16, reference numerals 611e and 611g denote pump drive signal wirings disposed on the mounting surface 503, and reference numeral 611f denotes a pump drive signal wiring disposed on the pad surface. The pump drive signal wiring 611e disposed on the mounting surface 503 and the pump drive signal wiring 611f disposed on the pad surface 502 are connected by a through-hole 607r. The pump drive signal wiring 611g disposed on mounting surface 503 and the pump drive signal wiring 611f disposed on the pad surface 502 are connected by a through-hole 607s.

As shown in FIG. 16, a protection area Z is provided around the pump drive signal wiring 611f on the pad surface 502. The protection area Z provided on the pad surface 502 is a set of points excluding points that are spaced apart from any point belonging to the pump drive signal wiring 611f by a distance D or more. The protection area Z provided on the pad surface 502 can also be said to be a set of points Q2 spaced apart from at least one point Q1 belonging to the pump drive signal wiring 611f by the distance D or less.

In a case of providing wiring on the pad surface 502, the same rules as in the first embodiment are applied to the protection area Z provided on the pad surface 502. For example, the ejection element drive signal wiring (differential) 618 and the ejection element output wiring (analog) 621 are provided in an area excluding the protection area Z. The EEPEROM setting signal wiring 616, the heater power supply wiring 620, and the logic power supply wiring 622 are provided in the area excluding the protection area Z, or are provided in the protection area Z after connecting a short circuit protection circuit. The ejection element drive signal wiring (non-differential) 623, the ejection element output wiring (digital) 624, and the IC control signal wiring 625 are also provided in the area excluding the protection area Z, or are provided in the protection area Z after connecting a short circuit protection circuit.

In the example of FIG. 16, all pads and through-holes (not shown) corresponding thereto are provided in the area excluding the protection area Z.

### Seventh Embodiment

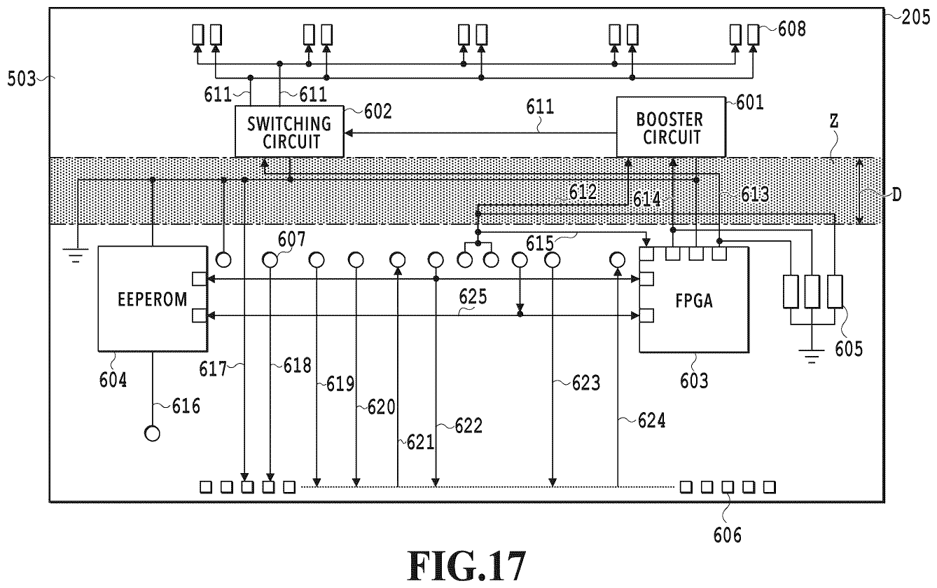

As shown in FIG. 17, an electric circuit board 205 according to a seventh embodiment is obtained by reducing the number of switching circuits 602 from two to one in the electric circuit board 205 as shown in FIG. 6. A single switching circuit 602 shown in FIG. 17 outputs a complementary pair of switched pump drive signal wirings. In other words, the single switching circuit 602 shown in FIG. 17 has a function that combines the functions of the pair of switching circuits 602 shown in FIG. 6. In the electric circuit board 205 shown in FIGS. 10 to 16, the pair of switching circuits 602 may be changed to a single switching circuit 602 that combines these functions.

### Eighth Embodiment

In the embodiments other than that shown in FIG. 16, the booster circuit 601, the switching circuit 602, and the pump drive signal wiring 611 are arranged only on the mounting surface 503. As shown in FIGS. 2 and 5, the mounting surface 503 faces the outer surface of the channel member 202.

An eighth embodiment adopts the configuration as described above. In the seventh embodiment, a glass epoxy material (FR-4 board or FR-5 board) is used as the material for the core material 803 (see FIG. 8) of the electric circuit board 205 so as to achieve V-0 grade in the UL94 flame retardancy standard. The thickness of the electric circuit board 205 is set to 1.7 mm. Therefore, even if smoke or fire starts from the vicinity of the booster circuit 601, the smoke or flame can be enclosed by the mounting surface 503 and the electric circuit board 205, preventing the fire from spreading.

### OTHER EMBODIMENTS

In the above embodiments, a Zener diode or a varistor is used as the short circuit protection circuit. By inserting a Zener diode or a varistor between a target wiring and the ground, the pump drive voltage can be prevented from being applied to the target wiring even if the pump drive signal wiring 611 is short-circuited with the target wiring.

However, the present disclosure is not limited to such a configuration, and a fuse circuit may be inserted as a short circuit protection circuit between a target wiring and an output terminal connected to the target wiring. Even if the pump drive signal wiring 611 is short-circuited with the target wiring, the fuse circuit can be operated to protect a circuit having the output terminal. By setting an operating current of the fuse circuit low, even if a wiring (for example, a low voltage wiring) other than the pump drive signal wiring 611 is short-circuited with the target wiring, the fuse circuit can be operated to protect the circuit having the output terminal. Similarly, a fuse circuit may be inserted as a short circuit protection circuit between a target wiring and an input terminal connected to the target wiring.

In the above embodiments, it is described that the protection area Z is provided below the lower sides of the booster circuit 601 and the switching circuit 602 in plan view of FIG. 6. However, although description is omitted, a protection area is also provided above the lower sides of the booster circuit 601 and the switching circuit 602. For example, a margin may be added and the entire area above the lower sides of the booster circuit 601 and the switching circuit 602 may be added as a protection area.

In the above embodiments, the description is given, as an example, of the configuration in which a plurality of circulating pumps are driven by a common pump drive signal, but the present disclosure is not limited thereto. For example, a pair of a booster circuit and a switching circuit may be provided on an electric circuit board for each circulating pump, and each pair may drive a corresponding circulating pump.

In the above embodiments, the description is given, as an example, of the configuration in which the pump reference signal wiring 612 and the FPGA power supply wiring 615 are connected in the electric circuit board 205, and the pads T20 and T12 are provided for each of them. However, the present disclosure is not limited thereto. The pump reference signal wiring 612 and the FPGA power supply wiring 615 may be separated in the electric circuit board 205. In this case, the FPGA power supply wiring 615 is disposed in an area other than the protection area Z, and thus no short circuit protection circuit needs to be connected thereto.

In the above embodiments, the pair of switching circuits 602 are disposed on the electric circuit board 205, but the present disclosure is not limited thereto. For example, the pair of switching circuits 602 may be arranged on an electric circuit board other than the electric circuit board 205.

A switching circuit 602 may be provided for each circulating pump corresponding to each color. In the first embodiment, if the number of colors is four and the switching circuit 602 is provided for each color, the number of switching circuits will be eight. In the seventh embodiment, if the number of colors is four and the switching circuit 602 is provided for each color, the number of switching circuits will be four. In these configurations, for example, four booster circuit drive signal wirings 614 may be provided to control a pump drive voltage for each color.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-151574, filed on Sep. 19, 2023, which is hereby incorporated by reference wherein in its entirety.

What is claimed is:

1. An electric circuit board comprising:
a booster circuit configured to generate a pump drive signal having a pump drive voltage for driving a circulating pump to circulate a liquid, by boosting a pump reference signal having a reference voltage based on a booster circuit drive signal;
a first wiring for transmitting the pump drive signal;
a second wiring for transmitting the pump reference signal;
a third wiring for transmitting the booster circuit drive signal; and
a plurality of fourth wirings for transmitting signals related to an ejection element configured to eject the liquid, wherein
the second wiring and the third wiring each have a portion disposed at a position spaced apart from the first wiring by a distance shorter than a protection distance, and have a short circuit protection circuit connected thereto, and
the plurality of fourth wirings include one or more first type wirings disposed at a position spaced apart from the first wiring by a distance longer than the protection distance.

2. The electric circuit board according to claim 1, further comprising:
at least one switching circuit for intermittently supplying the pump drive signal to the circulating pump based on a pump drive control signal; and
a fifth wiring for transmitting the pump drive control signal, wherein
the fifth wiring has a portion disposed at a position spaced apart from the first wiring by a distance shorter than the protection distance, and has a short circuit protection circuit connected thereto.

3. The electric circuit board according to claim 1, wherein
the first type wirings include at least any one of
a wiring for driving an energy conversion element included in the ejection element,
a wiring for transmitting an analog signal indicating a temperature of the ejection element,
a wiring for supplying a heater power supply voltage to a heater of the ejection element,
a wiring for supplying a heater ground voltage corresponding to the heater power supply voltage to the heater of the ejection element,
a wiring for transmitting a digital signal indicating a surface state of a heater electrode in an ejection module including the ejection element,
a wiring for setting an EEPEROM provided on the electric circuit board,
a wiring for supplying a logic power source to an energy conversion element included in the ejection module and a logic circuit mounted on the electric circuit board,
an IC control signal wiring, and
an ejection element drive signal wiring for supplying a signal indicating drive timing to the energy conversion element included in the ejection module including the ejection element by a method other than a differential transmission method.

4. The electric circuit board according to claim 1, wherein
the plurality of fourth wirings have a portion disposed at a position spaced apart from the first wiring by a distance shorter than the protection distance, and further include one or more second type wirings having a short circuit protection circuit connected thereto.

5. The electric circuit board according to claim 4, wherein
the second type wirings include at least any one of
a wiring for supplying a heater power supply voltage to a heater of the ejection element,
a wiring for transmitting a digital signal indicating a surface state of a heater electrode in an ejection module including the ejection element,
a wiring for setting an EEPEROM provided on the electric circuit board,
a wiring for supplying a logic power source to an energy conversion element included in the ejection module and a logic circuit mounted on the electric circuit board,
an IC control signal wiring, and
an ejection element drive signal wiring for supplying a signal indicating drive timing to the energy conversion element included in the ejection module including the ejection element by a method other than a differential transmission method.

6. The electric circuit board according to claim 1, wherein
the plurality of fourth wirings have a portion disposed at a position spaced apart from the first wiring by a distance shorter than the protection distance, and further include one or more third type wirings having no short circuit protection circuit connected thereto.

7. The electric circuit board according to claim 6, wherein
the third type wirings include at least any one of
a logic ground wiring,
a wiring for supplying a heater power supply voltage to a heater of the ejection element,
a wiring for supplying a heater ground voltage corresponding to the heater power supply voltage to the heater of the ejection element,
a wiring for transmitting a digital signal indicating a surface state of a heater electrode in an ejection module including the ejection element, and
a wiring for setting an EEPEROM provided on the electric circuit board.

8. The electric circuit board according to claim 1, wherein
the first wiring is disposed on a first surface of the electric circuit board,
an upper terminal corresponding to an upper board is provided on a second surface opposite to the first surface,
the upper terminal is connected to a wiring disposed on the first surface through a wiring and a through-hole provided on the second surface, and
the through-hole is disposed at a position spaced apart from the first wiring by a distance longer than the protection distance in plan view of the electric circuit board.

9. The electric circuit board according to claim 8, wherein
the upper terminal and the wiring disposed on the second surface are also disposed at positions spaced apart from the first wiring by a distance longer than the protection distance in plan view of the electric circuit board.

10. The electric circuit board according to claim 1, wherein
the first wiring is disposed on a first surface of the electric circuit board and a second surface opposite to the first surface,
an upper terminal corresponding to an upper board is provided on the second surface,
the upper terminal is connected to the wiring disposed on the first surface through wiring and a through-hole provided on the second surface, and
the through-hole is disposed at a position spaced apart from the first wiring disposed on the first surface and the first wiring disposed on the second surface by a distance longer than the protection distance in plan view of the electric circuit board.

11. The electric circuit board according to claim 10, wherein
the upper terminal and the wiring disposed on the second surface are also disposed at positions spaced apart from the first wiring disposed on the first surface and the first wiring disposed on the second surface by a distance longer than the protection distance in plan view of the electric circuit board.

12. The electric circuit board according to claim 1, wherein
the first wiring is disposed on a first surface of the electric circuit board,
an upper terminal corresponding to an upper board is provided on a second surface opposite to the first surface,
the upper terminal is connected to a first surface wiring disposed on the first surface through a second surface wiring and a through-hole provided on the second surface,
the through-hole is disposed at a position spaced apart from the first wiring by a distance shorter than the protection distance in plan view of the electric circuit board, and
a short circuit protection circuit is connected to the first surface wiring or the second surface wiring.

13. The electric circuit board according to claim 12, wherein
the upper terminal and the second surface wiring are arranged in an area of the second surface excluding a circular area centered at the through-hole with a radius set to a distance obtained by subtracting a distance between the first wiring and the through-hole and a thickness of the electric circuit board from the protection distance.

14. The electric circuit board according to claim 1, wherein
the first wiring is disposed on a first surface of the electric circuit board,
an upper terminal corresponding to an upper board is provided on a second surface opposite to the first surface,
the upper terminal is connected to a first surface wiring disposed on the first surface through a second surface wiring and a through-hole provided on the second surface,
the through-hole is disposed at a position spaced apart from the first wiring by a distance longer than the protection distance in plan view of the electric circuit board, and
no short circuit protection circuit is connected to the first surface wiring and the second surface wiring.

15. The electric circuit board according to claim 1, wherein
the short circuit protection circuit is activated when a wiring having the short circuit protection circuit connected thereto is short-circuited with the first wiring.

16. The electric circuit board according to claim 1, wherein
the short circuit protection circuit is activated when a wiring having the short circuit protection circuit connected thereto is short-circuited with a wiring different from the first wiring.

17. The electric circuit board according to claim 1, wherein
the protection distance is a distance that satisfies conditions stipulated in IEC 60950-1 for clearances.

18. The electric circuit board according to claim 1, wherein
the electric circuit board is mounted on a liquid ejection head including a liquid circulation unit including the circulating pump, and an ejection unit having a plurality of the ejection elements configured to eject a liquid supplied from the liquid circulation unit.

19. A liquid ejection head comprising:
an electric circuit board including
a booster circuit configured to generate a pump drive signal having a pump drive voltage for driving a circulating pump to circulate a liquid, by boosting a pump reference signal having a reference voltage based on a booster circuit drive signal,
a first wiring for transmitting the pump drive signal,
a second wiring for transmitting the pump reference signal,
a third wiring for transmitting the booster circuit drive signal, and
a plurality of fourth wirings for transmitting signals related to an ejection element configured to eject the liquid, wherein
the second wiring and the third wiring each have a portion disposed at a position spaced apart from the first wiring by a distance shorter than a protection distance, and have a short circuit protection circuit connected thereto, and
the plurality of fourth wirings include one or more first type wirings disposed at a position spaced apart from the first wiring by a distance longer than the protection distance;
a liquid circulation unit including the circulating pump; and
an ejection unit having a plurality of the ejection elements configured to eject a liquid supplied from the liquid circulation unit.

20. The liquid ejection head according to claim 19, wherein
the booster circuit and the first wiring are provided on a surface of the electric circuit board facing an outer surface of a channel member configured to accommodate the ejection unit, and
the electric circuit board satisfies V-0 in UL94 flame retardancy standard.
